(19) United States
(12) Patent Application Publication
(10) Pub. No.: US 2007/0149625 A1
(43) Pub. Date: Jun. 28, 2007

(54) Process for recycling waste plastics

(76) Inventors: David J. Lark, Woodburn,NSW (AU); William Alexander Howell, Ballina (AU)

Correspondence Address: T. D. FOSTER, 12760 HIGH BLUFF DRIVE, SUITE 300, SAN DIEGO, CA, 92130, US

(21) Appl. No.: 10/575,320

(22) PCT Filed: Oct. 12, 2004
(86) PCT No.: PCT/AU04/01389

§ 371 Date: Jan. 24, 2007

(30) Foreign Application Priority Data
Oct. 13, 2003 (AU) 2003905590

(51) Int. Cl. C08J 11/04

(52) U.S. Cl. 521/40

(57) ABSTRACT

A process for recycling plastic material by reducing a sample of plastic material to form plastic particles having a desired particle size; providing a susceptor agent to the plastic particles which imparts a dielectric property to the plastic particles; providing a bonding agent to the plastic particles; and treating the plastic particles with microwave energy to form a useable plastic material.

### TECHNICAL FIELD

The present invention relates to a process and apparatus for the recycling of waste plastics such as are found in municipal solids waste. The invention also relates to a wide range of value added items produced from the recycled plastic.

### BACKGROUND ART

Conventional plastic recycling processes aimed at reuse of used plastic items have required pre-sorting into defined plastic types, followed in most cases by segregation of the plastic from contaminants such as coloured lids and labels and washing of the plastic to remove soil and other forms of latent matter. Following such preparation, the sorted washed plastics are granulated and re-used either in combination with virgin plastics of the same type or in combination with defined groupings of plastic requiring specified percentages of the sorted plastics to produce reliable and re-useable products.

However, these existing plastics recycling processes have several disadvantages. Whilst it has been found that between 10-25% of sorted, washed recycled material can be incorporated into new products, the quality of the resulting plastic products limits their use due to the inclusion of such reclaimed material. This is the case, for example, when PVC pipe is extruded for the carriage of potable water, only reground virgin PVC, but not recycled PVC, can be used. Furthermore, considerable costs are involved in preparing used plastic items for re-use, including the cost associated with the pre-sorting, segregation, washing and granulation of the recycled plastic prior to its conversion into reusable items.

Extensive source separation of plastic items is commonplace in modern society, which greatly facilitates the recycling of some commercially valuable plastics species such as PET and HDPE. When these are withdrawn from the waste stream, a large fraction of other plastics remains, which are of substantially lower commercial value and are usually disposed to landfill. Alternatively, the waste can be converted to energy by such processes as gasification. Concerned parties see both fates as ecologically unacceptable.

While it is expected that traditional processing will continue to be utilised for the recycling of the higher value plastics, the present invention enables the conversion of the large fraction of plastic remaining in the waste stream into useable product.

Therefore, the present invention presents an unexpected enhancement of the methods and technologies available for the recycling of all plastics. This process for the recycling of mixed waste plastics employs techniques and apparatus, which have not previously been possible for this application, thereby offering an environmentally acceptable purpose and reducing the cost of processing these materials into reusable products in an efficient manner.

Previously, the recycling of unsorted mixed plastic material has been found to be problematic as the materials in the mixture have different processing and melting characteristics. In order to over come this problem in the past, the plastics have been sorted based on common chemical characteristics which is time consuming and expensive. The sorted plastics are then heated to melting and used to form new articles. The present inventors have developed an alternative process to recycle used plastics, particularly mixed plastic waste.

### DISCLOSURE OF INVENTION

In a general aspect, the present invention relates to a process for recycling plastic material by providing a common dielectric property to the plastic material and treating the plastic material using microwave energy.

In a first aspect, the present invention provides a process for recycling plastic material comprising:
(a) reducing a sample of plastic material to form plastic particles having a desired particle size;
(b) providing a susceptor agent to the plastic particles which imparts a dielectric property to the plastic particles;
(c) providing a bonding agent to the plastic particles; and
(d) treating the plastic particles with microwave energy to form a useable plastic material.

The process may further comprise:
(e) forming the plastic material into a solid product.

The process according to the present invention is particularly suitable for the treatment of mixed or unsorted plastics. It will be appreciated, however, that any plastic material can be used for the process according to the present invention.

Preferably, the plastic particles are formed by shredding or grinding the mixed plastic waste. Other suitable methods can be used to reduce the plastic material to a desired particle size such as commercially available plastic granulation, shredding or pulverisation equipment.

The particle size can be less than about 50 mm. Preferably, the particle size is about 0.5-20 mm. More preferably, the particle size is between about 1-5 mm. It will be appreciated, however, that the particle size can vary depending on the waste plastic material and the agents used.

As defined herein, a ‘susceptor agent’ is an agent which imparts a dielectric property to the plastic material making the plastic susceptible to microwave treatment and heating. The agent thus increases the ability to heat the plastic material by microwave energy. Preferably, the susceptor agent imparts a defined and increased dielectric property to the plastic particles.

Preferably, the susceptor agent has a dielectric property, or loss factor higher than that of the plastic particles. Examples suitable susceptor agents include, but are not limited to, carbon black, hydrocyanic acid, hydrogen peroxide, titanium dioxide, trimethylsulfanilic acid, hydrogen fluoride, formamide, glycerin, acetamide, formic acid, methyl alcohol, p-nitro analine, dimethyl sulfate, hydrazine, maleic anhydride, titanium oxide, or mixtures thereof.

In a preferred form, the susceptor agent is also a colouring agent. Preferably, the susceptor agent is carbon black. In a preferred form, the bonding agent contains the microwave susceptor agent which is receptive to microwave energy and heats up preferentially under microwave treatment. It will be appreciated that other colouring agents that are compatible in plastic may also be used together with other materials that are microwave susceptors or enhancers which would also be suitable for the present invention.

The susceptor agent can be added to the plastic particles in a proportion of between about 0.01% to 10% (w/w). Preferably, the susceptor agent is added at a proportion of between about 0.5% to 5% (w/w). Using carbon black, around 1 to 2% has been found to be quite suitable. It will be appreciated, however, that the amount used may depend on the plast cs material and the particular susceptor agent used.

Preferably, the bonding agent is a resin formed by dissolving one or more soluble plastics in a solvent such as an industrial solvent. The solvent and soluble plastic used to produce the bonding agent is preferably also recycled. Preferably, the bonding agent assists in forming a cohesive plastic material product.

The bonding agent can be added to the plastic particles in a proportion of between about 1% to 30% (w/w). Preferably, the bonding agent is added to the plastic particles in a proportion of between about 5% to 20% (w/w). More preferably, the bonding agent is added to the plastic particles at about 15% (w/w). It will be appreciated, however, that the amount used may depend on the plastics material and the particular bonding agent used.

In one preferred from, the bonding agent is formed by mixing the soluble plastic and solvent in a ration of about 1:1 to form a glue-like material. Other ratios such as about 0.5:1-5:1, preferably about 0.75:1-2.5:1, are also contemplated by the present invention.

In one preferred form, the susceptor agent is provided with the bonding agent.

Soluble plastics, such as polystyrene (PS), and solvents such as thinners, toluene or acetone have been found by the present inventors to be particularly useful. Other soluble plastics and solvents, well known to the art, would also be suitable for preparation of the bonding agent. Examples include, but not limited to, those shown in Table 1.

TABLE 1

| SOLVENT | SOLUBLE PLASTIC |
|---|---|
| m-Chlorobenzene | AC |
| Cyclohexane | AC, Nylon, PEEK, PS |
| Cyclohexanone | PVC, PS |
| Ethyl chloride | PP |
| Ethyl ether | PP |
| Furfuryl alcohol | PVC, HDPE |
| Isopropyl ether | AC |
| Ketones | AC |
| Methyl acetate | PP |
| Methyl chloride | PP, PVC |
| Methyl ethyl ketone | PVC, PPMA |
| Methylene chloride | PEEK |
| n-Octane | PP |
| n-Pentane | PP |
| Tetrahydrofuran | PEEK |
| Trichloroethylene | AC |
| Triethanol Amine | AC |

In a preferred form, the plastic particles, the bonding agent containing the microwave susceptor agent and optional colouring agent(s) are placed in a vessel equipped with a slowly rotating propeller where the elements are evenly combined to form a coated plastic material. Other vessels in which the coated plastic material can be blended by stirring, tumbling, or other similar processes are also suitable for the present invention.

In one form, a vacuum is applied to the coated plastic material to remove any potential harmful vapours generated during the microwave treating stage of the process, although the process in its broadest form does not necessitate vacuum.

Preferably, the vacuum when used is maintained between about 60 arid 260 milliBar absolute pressure. Although vacuum was used in many early experiments, it was found that the process does not require a vacuum to produce useful plastic products.

The plastic particles can be heated with microwave energy to a temperature from about 120° C. to about 230° C. Preferably, the contents of the vessel are heated with microwave energy to a temperature of at least about 150° C. It will be appreciated that the amount of microwave energy applied and the resulting temperature needed will depend on the amount and type of plastic to the processed.

The microwave frequency used in the present invention may be of a frequency in the order of 915 mHz or 2.45 gHz. These frequencies are those permitted for use in industrial microwave applications in Australia but other frequencies may also be used in the present invention. Microwaves are electromagnetic waves with wavelengths in the range of 10⁻³ to 0.03 m. One advantage of the use of microwave technology is that the heat generated by the interaction of the applied microwave energy with the microwave susceptor added in this process can be uniformly distributed throughout the coated waste plastic and therefore plastics which are normally quite insulatory and difficult to heat by traditional means are efficiently and substantially uniformly heated.

It will be appreciated that the amount of energy required will depend on the quantity of waste plastic being treated at any particular time and the type and ratio of microwave susceptor used.

In a preferred form, the microwave heating can be applied without agitation for a period not exceeding about 10 minutes and the heating is then continued with agitation. In another preferred form, the heating period used in the present invention is between about 10 to 200 minutes. Preferably, the coated plastic material is heated less than about 150 minutes. More preferably, the contacting period is less than about 50 minutes. It will be appreciated that the duration of heating can vary depending on the volume of coated plastic material and the power of the heating apparatus used.

Once treated, molten or liquid, the plastic material can be conveyed while still hot to any suitable moulding or processing equipment where it can be compression moulded, injection moulded or extruded in conventional plastic forming equipment.

The process according to the present invention may be performed batch-wise or continuously in a suitable vessel or through a suitable apparatus such as a screw conveyor. When a batch method is used, the components can be loaded and unloaded into a treatment vessel manually or by automated means. When a continuous flow mode is desired, commercially available materials-handling equipment utilising for example a conveyor or other means to feed the final mixture through the heating stage can be used.

The process is suitable for mixed plastics or single waste plastic streams.

In a second aspect, the present invention provides plastic material obtained by the process according to the first aspect of the present invention.

Preferably, the plastic material is mixed waste plastic material.

In a third aspect, the present invention provides a plastic product produced from the plastic material according to the second aspect of the present invention.

Throughout this specification, unless the context requires otherwise, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed in Australia before the present invention was made.

In order that the present invention may be more clearly understood, preferred forms will be described with reference to the following drawings and examples.

### BRIEF DESCRIPTION OF THE DRAWINGS

FIG. 1 shows a schematic diagram of apparatus suitable for the process according to the present invention.

### MODE(S) FOR CARRYING OUT THE INVENTION

Waste Material

Plastic materials that can be recycled by the process and apparatus of the present invention include, but are not limited to the plastic categories set out in Table 2.

TABLE 2

| Acronym | Chemical or Common Name |
|---|---|
| AC | Acetal |
| ABS | Acrylonitrile butadiene styrene |
| ASA | Acrylate styrene acrylonitrile |
| CA | Cellulose acetate |
| EVA | Ethylene vinyl acetate |
| EVOH | Ethylene vinyl alcohol |
| HDPE (PE-HD) | High density polyethylene |
| HIPS | High impact polystyrene |
| LDPE (PE-LD) | Low density polyethylene |
| LLDPE (PE-LLD) | Linear low density polyethylene |
| MDPE (PE-MD) | Medium density polyethylene |
| PA6 | Polyamide (Nylon) type 6 |
| PA11 | Polyamide (Nylon) type 11 |
| PA12 | Polyamide (Nylon) type 12 |
| PA66 | Polyamide (Nylon) type 66 |
| PBT | Polybutylene terephthalate |
| PC | Polycarbonate |
| PEEK | Polyether ether ketone |
| PE | Polyethylene |
| PES | Poly ether sulphone |
| PMMA | Polymethyl methacrylate (Acrylic) |
| POM | Polyoxymethylene (Acetal, Polyformaldehyde) |
| PPO | Polyphenylene oxide |
| PP (PPN) | Polypropylene |
| PPC | Polypropylene copolymer |
| PPH | Polypropylene homopolymer |
| PS | Polystyrene |
| PTFE | Polytetrafluoroethylene |
| PVC | Polyvinyl chloride |
| PVC-C | Chlorinated polyvinyl chloride |
| PVC-P | Plasticised polyvinyl chloride |
| PVC-U (uPVC) | Unplasticised polyvinyl chloride |
| SAN | Styrene acrylonitrile copolymer |
| TPE | Thermoplastic elastomer |
| TPO | Thermoplastic olefin |
| TPU | Thermoplastic polyurethane |
| TPR | Thermoplastic rubber |
| XPS | Expandable polystyrene |

Apparatus

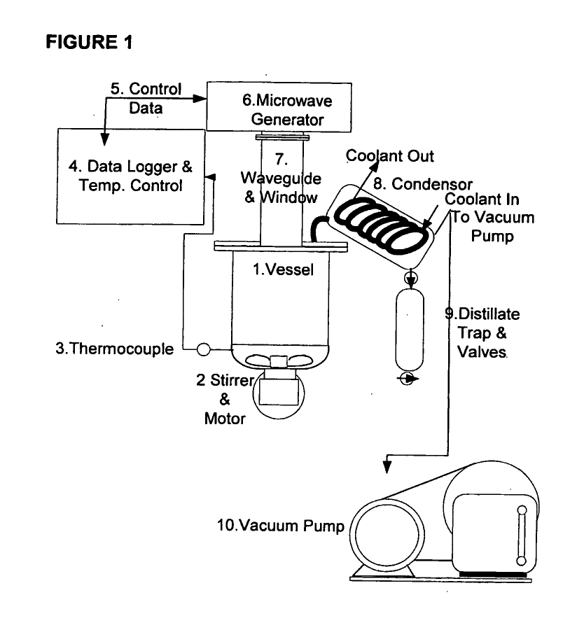

An apparatus for performing the process according to this invention in batch mode is shown diagrammatically in FIG. 1.

The apparatus comprises the following components

Vessel (1) equipped with a stationary lid having an O-ring seal and means for microwave entrapment. The vessel is held closed by the applied force of an applied vacuum. When vacuum is released, the vessel is lowered providing unimpeded access to add or remove material for treatment.

Stirrer & Motor (2) with reduction gearbox and speed control to provide variable mixing speed and high torque required to mix the treated plastic by the action of a propeller mixer.

Thermocouple (3) to sense the temperature of the melting material in the vessel. The thermocouple, which is a standard Type K, is mounted so that it is earthed to the wall of the vessel and does not act as an aerial for microwaves.

Data Logger & Temperature Control (4) to record heating profiles and control the microwave energy delivery by the microwave generator to the material being heated in the vessel

Control Data (5) to switch microwave generation by the microwave generator (6).

Microwave Generator (6) to provide heating energy to the vessel (1) equipped with a 1 kW, 2.45 gHz magnetron and power supply.

Waveguide & Window (7) to conduct the microwave power from the microwave generator (6) to the vessel (1) to heat the material being processed. The window contains a tuned block of low dielectric plastic material, such as solid PTFE, sized to minimise microwave reflection but thick enough to not distort under vacuum when heated during operation.

Condenser (8) cooled by refrigerated coolant to retain solvents and off-gases produced from the plastic by vacuum and heating.

Distillate Trap & Valves (9) to entrap distillate produced.

Vacuum Pump (10) to generate the vacuum to hold vessel (1) closed, lower the boiling point of the solvents in the mix and facilitate their removal and provide a non-oxidant atmosphere so that plastic and solvent were not able to ignite.

Definitions

EWT Residue

Dirty and damp plastics are currently disposed as land-fill after the organics and metals are removed. A typical residue contained:
LDPE 70%
PET 6%
HDPE 8%
VINYL 2%
PP 2%
OTHER 12%
   BSC

Obtained from Ballina Shire Council. This typical mixture is contaminated with all the container residues like milk, cream, toothpaste, juice, ice cream, cordials, cleaners, detergents, soap, in fact everything that is plastic packaged for household use. Also contained the labels on the various containers.

A typical residue contained:

VINYLS 25%
HDPE25%
LDPE 10%
PET 25%
Other 10%
   Mixed Plastic Paper and Labels

This mix comprised the following
Pulverised paper 35%
Mixed plastics 55%
Container labels 10%
   RETH Mix

Contained the following plastic combinations
PET 12%
HDPE 16%
Mixed 7%
LDPE 50%
Other 15%

### METHODS & EXAMPLES

### Example 1

In order to produce a pipe for testing the properties of the combined plastic the following mix was prepared and processed with the parameters as shown in Table 3.

TABLE 3

| Plastic Mixture shredded | |
|---|---|
| and granulated to 3-15 mm | Amount |
| PVC | 20% w/w |
| PP | 20% w/w |
| PET | 20% w/w |
| HDPE | 20% w/w |
| PAPER | 4% w/w |
| FLY ASH | 5% w/w |
| Carbon Black | 1% w/w |
| Mixed Waste Solvents (Thinners) | 5% w/w |
| XPS | 5% w/w |

| Processing Parameters | Value |
|---|---|
| Production (kg) | 1 |
| Vacuum (millibar) | 260 |
| Temperature Set Point (° C.) | 200 |
| Maximum Temperature (° C.) | 215 |
| Ambient Temperature (° C.) | 26 |
| Heating Time (mins) | 45 |

The treated plastic was transferred from the vessel and allowed to cool in approximately 200 gm mounds, in ambient air until solid and at ambient temperature. After several days the un-formed mounds were reduced to a fine, approximately 20 mesh, powder by granulation and pulverisation.

The powder was then reheated in the apparatus as previously described, and the treated plastic pressed into a mould with nominal ID of 375 mm corresponding to the dimensions of similar standard Class 2 concrete or Class 2 reinforced concrete pipe.

After cooling, this sample was subjected to functional testing by independent laboratories and the following results were obtained as shown in Table 4.

TABLE 4

| TEST | RESULT |
|---|---|
| Hydrostatic | 980 kPa |
| Density | 1.1 |
| Hardness | 60, 67 |
| Flexural Strength | 15.7 mPa |
| Compression | 42.2 mPa |
| % Increase In Weight After Immersion In | 0.14, O.53 |
| Water | |

The pipe produced was found to have characteristics which were far better than a Class 2 concrete pipe of similar dimensions except that it was less than half the weight, expected for such a concrete pipe.

Further work on the process development was performed and it was found, somewhat surprisingly, that the process according to the present invention could be combined into a one step process, eliminating the need to waste heat and time and no longer requiring the regrind step. This has become a preferred process of the invention and will now be described in Example 2.

The choice of plastic mix is by way of example only and is not limited to the proportions or types of plastics chosen for each working example.

### Example 2

In order to produce a pipe for testing the properties of the combined plastic the following mix was prepared and processed with the parameters as shown in Table 5.

TABLE 5

| Plastic Mixture shredded | | |
|---|---|---|
| and granulated to 1-5 mm | Amount | |
| PVC | 5% | w/w |
| PP | 23% | w/w |
| PET | 18% | w/w |
| HDPE | 20% | w/w |
| PA (NYLON) | 5% | |
| PE/GLASS MIXTURE | 3% | |
| LDPE/GLASS/ALUMINIUM/PAPER LABELS | 5% | |
| PC (POLYCARBONATE) | 5% | |
| Carbon Black | 1% | w/w |
| Mixed Waste Solvents (Thinners) | 5% | w/w |
| XPS | 5% | w/w |

| Processing Parameters | Value |
|---|---|
| Production (kg) | 2.2 |
| Vacuum (millibar) | 270 |
| Microwave Power (kW) | 1 |
| Microwave Frequency (gHz) | 2.45 |
| Temperature Set Point (° C.) | 190 |
| Maximum Temperature (° C.) | 210 |
| Ambient Temperature (° C.) | 21 |
| Heating Time (mins) | 50 |

The treated plastic was then pressed into a mould with dimensions of an 80 mm ductile iron pipe, the dimensions also corresponding to the now discontinued asbestos cement concrete pipe (OD 96 mm×ID 81 mm). The section of pipe formed and tested was 400 mm long.

After cooling, this sample was subjected to functional testing by independent laboratories and the following results were obtained as shown in Table 6.

TABLE 6

| TEST | RESULT |
|---|---|
| Hydrostatic | 1950 kPa |
| Density | 0.979, 1.031 |
| Hardness | 64-71 |
| Flexural Strength | 15.7 mPa |
| Compression | 42.2 mPa |
| % Increase In Weight After Immersion | 0.32-1.37 |
| In Water | |

The pipe produced was found to have characteristics which exceeded Class 2 concrete pipe and compared favourably with Class 12 UPVC pressure pipe. Again pipe produced achieved these parameters while weighing less than half the weight of a corresponding concrete pipe.

### Example 3

In order to assess the potential to incorporate LDPE shopping bags without compromising the product's integrity, the following mix was used to produce a pipe and processed with the parameters as shown in Table 7.

TABLE 7

| Plastic Mixture shredded | | |
|---|---|---|
| and granulated to 1-5 mm | Amount | |
| PVC | 5% | w/w |
| PP | 15% | w/w |
| PET | 17% | w/w |
| HDPE | 17% | w/w |
| LDPE (PLASTIC SHOPPING BAGS) | 20% | |
| PET/PAPER LABELS/LIDS | 5% | |
| LDPE/GLASS/PAPER LABELS | 5% | |
| Carbon Black | 1% | w/w |
| Mixed Waste Solvents (Thinners) | 5% | w/w |
| XPS | 5% | w/w |

| Processing Parameters | Value |
|---|---|
| Production (kg) | 2.2 |
| Vacuum (millibar) | 270 |
| Microwave Power (kW) | 1 |
| Microwave Frequency (gHz) | 2.45 |
| Temperature Set Point (° C.) | 190 |
| Maximum Temperature (° C.) | 210 |
| Ambient Temperature (° C.) | 22 |
| Heating Time (mins) | 50 |

The treated plastic was then pressed into a mould with dimensions as described in Example 2. The resultant pipe did not differ in outcome, appearance or functionality to that produced in Example 2, thus confirming the ability of the process to accommodate LDPE shopping bags, without modification to the process and without compromising the product.

### Example 4

EWT granulated plastic residue, damp
Liberal squirt of dishwashing detergent
Total of 8 min in microwave treatment with 3 stops.
Result—Reached beginning of melting process.

### Example 5

EWT granulated plastic residue (65%)
BSC (35%)
Carbon black (0.5%)
Result—After initial 8 mins poor result. Dishwashing detergent added and the plastic immediately started to get hot. Ran in microwave for 20 min with some melt achieved.

### Example 6

EWT granulated plastic residue (60%)
BSC (35%)
Castor Oil (5%)
Result—After 8 min microwave treatment product was extremely hot with visible liquid in vessel. EWT added which melted instantaneously and disappeared into the mix.

### Example 7

EWT granulated plastic residue 65%
BSC 35%
Bonding agent (polystyrene 1:1 thinners)
Castor Oil
Carbon black
Result—After 12 min of heating product had melted extremely well ready for pressing.

### Example 8

Same as Example 7 with no castor oil.
Result—Similar result as in Example 7 achieved.

### Example 9

Same as Example 7 with no carbon black.
Result—Heated for 10 min with no substantial gain in heating. Carbon black then added and heated for a further 13 mins with good melt achieved in product.

### Example 10

These experiments were conducted for the purpose of finding a product that absorbs microwaves, that in turn could assist as an accelerant for melting the plastic. However, initial findings indicate that no further additives were necessary as the original recipe achieved rapid heating in its current format.

TABLE 8

| MATERIALS HEATED | HEATING TIME | RESULT |
|---|---|---|
| Rethmann | 20 seconds | No result |
| PVC Powder | 20 seconds | Got warm |
| Polyethylene | 20 seconds | No result |
| Mixed plastic, paper, labels | 20 seconds | Got warm |
| EWT plastic residue | 20 seconds | Got warm |
| PC | 20 seconds | Heated slightly |
| PP | 20 seconds | No result |
| Pet - HDPE | 20 seconds | No result |
| HDPE | 20 seconds | No result |
| LDPE glass aluminium paper | 20 seconds | No result |
| Polystyrene | 20 seconds | No result |
| Pipe mix | 20 seconds | No result |
| PE, nylon glass | 20 seconds | Got warm |
| EWT plastic waste, damp | 20 seconds | Got hot |
| BSC plastic waste | 20 seconds | No result |
| Titanium Dioxide | 20 seconds | Got warm |
| Carbon | 20 seconds | Got hot |
| Bonding agent (PS and thinners) | 20 seconds | Got hot |

### Example 11

These experiments identified the rapid increase in temperature using Titanium Dioxide, EWT Residue Damp, EWT Residue and Carbon.

TABLE 9
Ambient Temp 18° C.

| | Sample | Time | | | Temp |
|---|---|---|---|---|---|
| | size | exposed | Temp in | Temp | Change |
| | (Grams) | (seconds) | (° C.) | out (° C.) | (° C.) |
| Control | | | | | |
| Water | 200 | 30 | 17 | 34 | 17 |
| | 200 | 60 | 17 | 45.1 | 28.1 |
| Products | | | | | |
| PVC Powder | 200 | 60 | 18.2 | 40 | 21.8 |
| Mixed plastic, paper | 200 | 60 | 20.1 | 38.3 | 18.2 |
| and labels | | | | | |
| EWT Residue | 200 | 60 | 21.2 | 52 | 30.8 |
| EWT Residue Damp | 200 | 60 | 17.1 | 82 | 64.9 |
| PC | 200 | 60 | 19 | 36 | 17 |
| Titanium Dioxide | 200 | 60 | 18 | 78 | 60 |
| Carbon* | 200 | 60 | 18.2 | 80 | 61.8 |

*Carbon had a hot spot which was glowing red and measured approximately 160° C.

### Example 12

33% EWT residue
33% BSC residue
33 % mixed plastic paper and labels
To the above was added:
15% by weight bonding agent in the form of PS and thinners (1:1)
1% by weight carbon black
Result: Superb example suitable for high end applications including the building industry such as timber replacement. Drills, nails, screws and can be worked with a lathe to form a thread or other shapes

### Example 13

66% EWT residue
34% mixed plastic paper and labels
To the above was added
15% by weight bonding agent—PS and thinners (1:1)
1% carbon black
Result Great example suitable for many mid range applications in the building industry. Very suitable for pallets, fence posts, vineyard poles, and perhaps pavers and blocks for retaining walls.

### Example 14

16% PET
22% HDPE
10% PP
11% PC
22% PE
19% mixed plastic paper and labels
To the above was added:
20% by weight bonding agent—PS and thinners (1:1)
1% carbon black
2% white colour agent
Result Brilliant example—resembled darker coloured grey concrete or marble, Multitude of uses including decorative products in the building industry. Piers, columns, blocks and bricks.

### Example 15

100% BSC mix
Yellow colour agent (5% max)
To the above was added:
15% by weight bonding agent—PS and thinners (1:1)
1% carbon black
Result Very good example. Speckled yellow is not at all unattractive in appearance. This example has wide uses as timber replacement products.

### Example 16

75% EWT residue
25% mixed plastic paper and labels
To the above was added:
22% by weight bonding agent—PS and thinners (1:1)
1.5% carbon black
Result Solid example, low end use in non-structural applications, poor load bearing qualities. May have use in a sandwich method using this product as a filler surrounded by better quality material.

Independent test results of plastic products produced by the process according to the present invention are shown in Table 10. These results highlight the good outcomes from a number of plastic recipes which are suitable for making vineyard poles and other timber replacement products.

TABLE 10

| Test | Result |
|---|---|
| Hydrostatic | 1950 KPa |
| Density | 0.979-1.031 |
| Hardness | 64-71 |
| Flexural Strength | 15.7 MPa |
| Compression | 42.2 MPa |
| % increase in weight | 0.32-1.37 |
| after immersion in | |
| water | |
| Leachate | No environmental issues after 170 hours |
| | at 40° C. |
| UV | No visible deterioration after 300 hours |
| Tensile Strength | 3.7-5.1 |
| Heat exposure | No visible deterioration at 110° C. |
| Termite Resistance | Favourable to date as tested |

Uses

The recycled material according to the present invention is suitable for, but not limited to, the formation of a wide range of concrete and timber replacement products. Examples are shown in Table 11:

TABLE 11

| INDUSTRY | PRODUCT |
|---|---|
| Agricultural | Fence posts, Stakes |
| Building & Construction | Grates, Bases for temporary fencing, |
| | Head walls, Hydrant Surrounds, Man |
| | Holes & Covers, Pipe - stormwater, |
| | sewerage, irrigation |
| Garden Furniture & Horticulture | Planter Boxes, Decorative Sleepers, |
| | Nursery Pots, Garden Seating & Tables |
| Industrial | Pallets, Bins |
| Landscaping | Grills, Pavers, Decking |
| Recreation | Wharf timbers, Decking |
| Traffic Control | Bollards, Parking Buffers, Kerbs & |
| | Gutters |

Summary

The current prices plastic manufactures are paying for raw materials are Polypropylene $2200/tonne, Polystyrene $2700/tonne, LDPE $2500/tonne, Nylon $5300/tonne, PVC $2400/tonne, and HDPE $2300/tonne.

The present technology can produce plastic material for subsequent uses at significant less costs compared with new raw materials set out above. Thus, many plastic products can be manufactured from plastic materials recycled by the process according to the present invention instead of using virgin plastic at the above prices.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1-29. (canceled)

30. A process for recycling plastic material comprising:
a) reducing plastic material to form plastic particles having a desired particle size;
b) providing a susceptor agent selected from the group consisting of carbon black, hydrocyanic acid, hydrogen peroxide, titanium dioxide, trimethylsulfanilic acid, hydrogen fluoride, formamide, glycerin, acetamide, formic acid, methyl alcohol, p-nitro analine, dimethyl sulfate, hydrazine, maleic anhydride, titanium oxide, and mixtures thereof to the plastic particles which imparts a dielectric property to the plastic particles;
c) providing a bonding agent to the plastic particles; and
d) treating the plastic particles with microwave energy to form a useable plastic material.

31. The process according to claim 1 further comprising: forming the plastic material into a solid product.

32. The process according to claim 1 wherein the plastic material is mixed or unsorted waste plastic material.

33. The process according to claim 1 wherein the plastic particles are formed by shredding, granulating, pulverizing or grinding.

34. The process according to claim 1 wherein the particle size is less than about 50 mm.

35. The process according to claim 5 wherein the particle size is 0.5 to 20 mm.

36. The process according to claim 6 wherein the particle size is between about 1 and 5 mm.

37. The process according to claim 1 wherein the susceptor agent imparts a defined and increased dielectric property to the plastic particles.

38. The process according to claim 1 wherein the susceptor agent is carbon black.

39. The process according to claim 1 wherein the susceptor agent is added to the plastic particles in a proportion of between 0.01% to 10% (w/w).

40. The process according to claim 10 wherein the susceptor agent is added at a proportion of between 0.5% to 5% (w/w).

41. The process according to claim 1 wherein the bonding agent is a resin formed by dissolving one or more soluble plastics in a solvent.

42. The process according to claim 1 wherein the bonding agent is formed by adding a soluble plastic to a solvent in a ratio of from 0.75:1 to 2.5:1.

43. The process according to claim 13 wherein the bonding agent is formed by adding a soluble plastic to a solvent in a ratio of about 1:1.

44. The process according to claim 13 wherein the soluble plastic is polystyrene and the solvent is thinners, toluene or acetone.

45. The process according to claim 13 wherein the soluble plastic is selected from the group consisting of Acetal, Nylon, PEEK, Polystyrene, Polypropylene, Polyvinyl chloride, High density Polyethylene, Polymethyl methacrylate(acrylic) and mixtures thereof.

46. The process according to claim 13 wherein the solvent is selected from the group consisting of m-Chlorobenzene, Cyclohexane, Cyclohexanone, Ethyl chloride, Ethyl ether, Furfuryl alcohol, Isopropyl ether, Ketones, Methyl acetate, Methyl chloride, Methyl ethyl ketone, Methylene chloride, and mixtures thereof.

47. The process according to claim 1 wherein the bonding agent is added to the plastic particles in a proportion of between 1% to 30% (w/w).

48. The process according to claim 18 wherein the bonding agent is added to the plastic particles in a proportion of between 5% to 20% (w/w).

49. The process according to claim 19 wherein the bonding agent is added to the plastic particles at about 15% (w/w).

50. The process according to claim 1 wherein the susceptor agent is provided with the bonding agent.

51. The process according to claim 1 further comprising a coloring agent or other additive.

52. The process according to claim 1 wherein a vacuum is applied during the process.

53. The process according to claim 1 wherein the plastic particles are heated with microwave energy to a temperature from 120° C. to 230° C.

54. The process according to claim 24 wherein the plastic particles are heated with microwave energy to a temperature of at least about 150° C.

55. The process according to claim 1 wherein the microwave heating is applied while the plastic particles are agitated or mixed.
